(19) United States
(12) Patent Application Publication
(10) Pub. No.: US 2024/0007443 A1
(43) Pub. Date: Jan. 4, 2024

(54) DATA SHARING SYSTEM AND DATA SHARING METHOD

(71) Applicant: Hitachi, Ltd., Tokyo (JP)

(72) Inventors: Masayuki SAKATA, Tokyo (JP); Yohsuke ISHII, Tokyo (JP)

(21) Appl. No.: 18/125,192

(22) Filed: Mar. 23, 2023

(30) Foreign Application Priority Data
Jun. 30, 2022 (JP) 2022-106559

(51) Int. Cl. H04L 9/40

(52) U.S. Cl. CPC H04L 63/04; H04L 63/107

(57) ABSTRACT

A data sharing system and method eases the sharing of original data, including data to be modified before publication, by modifying the original data to generate publication data before publication and publishing the publication data. A profile including information of a data acquisition area from which the original data is acquired and a list of types of data included in the original data is generated. For each of the plurality of areas based on the profile, pre-publication modify processing information storing, in association with each other, the name of a pre-publication modify type of data to be modified before publication and the name of a modify processing for modifying the data of the pre-publication modify type is generated. Further, a public data disclosure unit is configured to generate public data obtained by modifying the original data by the modify processing based on the pre-publication modify processing information.

### CROSS-REFERENCE TO RELATED APPLICATION

The present application claims priority from Japanese application JP2022-106559, filed on Jun. 30, 2022, the contents of which is hereby incorporated by reference into this application.

### BACKGROUND OF THE INVENTION

### 1. Field of the Invention

The present invention relates to a data sharing system including data management devices in a plurality of areas, wherein the data management devices in the plurality of areas are connected to each other via a network and share data, and a data sharing method.

### 2. Description of the Related Art

Various kinds of information are disclosed and shared throughout the world via a computer network (hereinafter, also referred to as a “network”). There are information whose disclosure is restricted, such as personal information whose disclosure is restricted by laws and regulations. Therefore, there are technologies for restricting disclosure of information whose disclosure is restricted.

For example, in JP 2020-87167 A disclosed a data transfer management system that determines whether data including personal information and generated in real time, can be transferred from a region in which handling of data is regulated to the outside, and that manages the transfer of the data. By using the data transfer management system disclosed in JP 2020-87167 A, when data generated in real time includes information whose disclosure is restricted, disclosure of the data can be restricted.

### SUMMARY OF THE INVENTION

By the way, the technology disclosed in JP 2020-87167 A, can manages the transfer of data including personal information and generated in real time. Therefore, in the case where disclosing data that does not include personal information or data that is not generated in real time are disclosed, the technology disclosed in JP 2020-87167 A cannot be used. In addition, the technology disclosed in JP 2020-87167 A cannot be used, in the case there are data whose publication is restricted other than personal information, or in the case that sharing modified data generates for ease to use before publishing is preferable.

Therefore, an object of the present invention is to provide a data sharing system and a data sharing method, that makes it easy to share original data, including data to be modified before publication, by modifying the original data to generate publication data before publication and publishing the publication data.

In order to attain the object described above, one aspect of a data management device of the invention is a data sharing system including data management devices in a plurality of areas, wherein the data management devices in the plurality of areas are connected to each other via a network and share data, the data sharing system comprising: a profile generation unit configured to generate, when original data is acquired, a profile including information of a data acquisition area from which the original data is acquired and a list of types of data included in the original data; a modify process information unit configured to generate, for each of the plurality of areas based on the profile, pre-publication modify processing information storing, in association with each other, the name of a pre-publication modify type of data to be modified before publication among types of data included in the original data and the name of a modify processing for modifying the data of the pre-publication modify type; and a public data disclosure unit configured to generate public data obtained by modifying the original data by the modify processing based on the pre-publication modify processing information, and to store the public data in the data management device.

In addition, one aspect of a data sharing method of a data sharing system of the invention is a data sharing method of a data sharing system including data management devices in a plurality of areas, wherein the data management devices in the plurality of areas are connected to each other via a network and share data, the method comprising: generates, when original data is acquired, a profile including information of a data acquisition area from which the original data is acquired and a list of types of data included in the original data; generate, for each of the plurality of areas based on the profile, pre-publication modify processing information storing, in association with each other, the name of a pre-publication modify type of data to be modified before publication among types of data included in the original data and the name of a modify processing for modifying the data of the pre-publication modify type; and generate public data obtained by modifying the original data by the modify processing based on the pre-publication modify processing information, and to store the public data in the data management device.

According to the invention, it is possible to make it easy to share original data, including data to be modified before publication, by modifying the original data to generate publication data before publication and publishing the publication data.

Objects, configurations, and effects other than those described above will be obvious by the following description of Example.

### BRIEF DESCRIPTION OF THE DRAWINGS

FIG. 1 is an example of a system configuration diagram of an outline of a data sharing system of Example;

FIG. 2 is a diagram showing an example of a function block diagram of the data sharing system of Example;

FIG. 3 is a block diagram showing an example of a hardware configuration of the data sharing system of Example;

FIG. 4 is a diagram showing an example of a information modify processing table;

FIG. 5 is a diagram showing an example of a data acquisition area modify processing table;

FIG. 6 is a diagram showing an example of a data sharing area modify processing table;

FIG. 7 is a diagram showing an example of a number of times of access table;

FIG. 8 is a diagram showing an example of a data acquisition area policy table;

FIG. 9 is a diagram showing an example of a data sharing area policy table;

FIG. 10 is a diagram showing an example of a data sharing area modify processing table;

FIG. 11 is a diagram showing an example of a data catalog table;

FIG. 12 is a diagram showing an example of a data status table;

FIG. 13 is a diagram showing an example of a display priority table;

FIG. 14 is an explanatory diagram showing an outline of processing of the data sharing system;

FIG. 15 is a flowchart showing an example of the profile generation processing of Example;

FIG. 16 is a diagram showing an example of a profile;

FIG. 17 is a flowchart showing an example of the information modify processing of Example;

FIG. 18 is a flowchart showing an example of first public data disclosure processing of Example;

FIG. 19 is a flowchart showing an example of second public data disclosure processing of Example;

FIG. 20 is an explanatory diagram showing a data viewing screen including the public file operation menu displayed on the user terminal;

FIG. 21 is an explanatory diagram showing a policy table edit screen;

### DETAILED DESCRIPTION OF THE PREFERRED EMBODIMENTS

Hereinafter, Example of the invention will be described with reference to the drawings. However, the present invention should not be construed as being limited to the description of the following examples. It is easily understood by those skilled in the art that the specific configuration can be modified without departing from the spirit and scope of the present invention.

In the configuration of the invention described below, the same or similar configurations or functions are denoted by the same reference numerals, and redundant description will be omitted.

In this specification and the like, expressions such as “first”, “second”, and “third” are used to identify components, and do not necessarily limit the number or order of components.

Herein, in this specification and the like, an expression “XX table” may be used as an example of various types of information, but the information may be expressed by a data structure such as an “XX list” or an “XX queue.” When describing the identification information, expressions such as “identification information”, “identifier”, “name”, “ID”, and “number” are used, but these can be replaced with each other.

In the examples of this specification, processing performed by executing a program may be described. Here, the computer executes a program by means of a processor (CPU, GPU, for example), and performs processing determined by the program while using storage resources (for example, memory), interface devices (for example, communication ports), or the like. Therefore, the subject of the processing performed by executing the program may be the processor. Similarly, the subject of the processing performed by executing the program may be a controller, a device, a system, a calculator, or a node including the processor. The subject of the processing performed by executing the program may be an operation unit, or may include a dedicated circuit performing specific processing. Here, the dedicated circuit, for example, is a field programmable gate array (FPGA), an application specific integrated circuit (ASIC), a complex programmable logic device (CPLD), or the like.

A program may be installed on a computer from a program source. The program source may be, for example, a program distribution server or a storage medium readable by a computer. When the program source is a program distribution server, the program distribution server may include a processor and a storage resource that stores a program to be distributed, and the processor of the program distribution server may distribute the program to be distributed to another computer. Further, two or more programs may be implemented as one program, or one program may be implemented as two or more programs.

### Example

The data sharing system 1 of the embodiment includes data management devices 100 in a plurality of areas. The data management devices in the plurality of areas are connected to each other via a computer network and share data.

### <<Overview of System Configuration of Data Sharing System 1>>

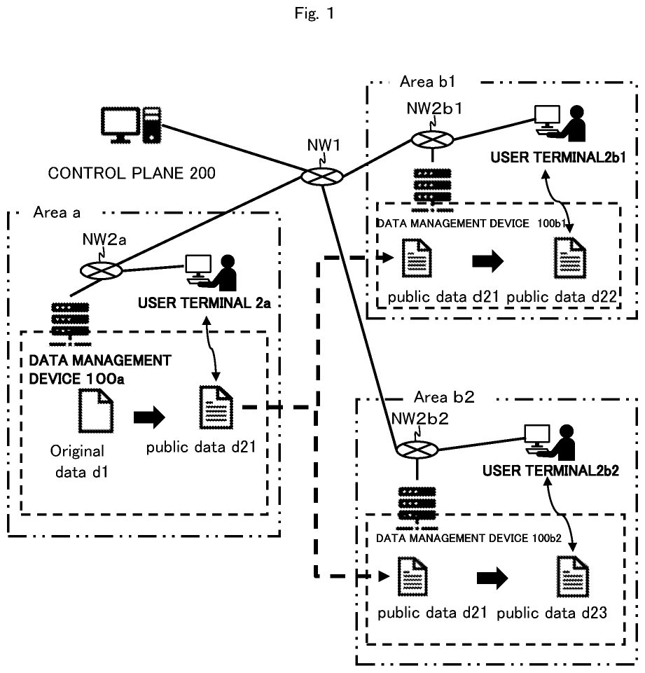

FIG. 1 is an example of a system configuration diagram of an outline of a data sharing system of Example. As outlined in FIG. 1, the data sharing system 1 has, for example, a data management device 100a in area a, a data management device 100b1 in area b1, a data management device 100b2 in area b2, and a control plane 200. These data management devices 100a to 100b2 and control plane 200 are connected via networks NW1, NW2a, NW2b1 and NW2b2.

Note that an area can be any area that contains at least one data management device 100 and at least one user terminal 2 connected to each other by a network NW, and there is no limit to the size of the area. An area can be, for example, a city, a town, or a country. Japan, US, and EU described in this specification are examples of areas.

Network NW1, NW2a, NW2b1, and NW2b2 can be networks, for example, the Internet. Network NW1 is, for example, a global network. The networks NW2a, NW2b1 and NW2b2 in the area may be, for example, the Internet, local area networks (LAN), wired networks or wireless networks.

The configuration of data management devices 100a to 100b2 is similar between data management devices 100a to 100b2. The data management devices 100a to 100b2 are generically referred to as “data management device 100.” Each data management device 100a to 100b2 is connected to user terminal 2 via networks NW2a, NW2b1 and NW2b2 in each area.

Users of user terminal 2a in area a can manipulate user terminal 2a to send original data d1 for publishing to the data management device 100a in area a. Within area a, when data management device 100a acquires original data d1, data management device 100a modifies the original data d1 to generate a public data d21 for publication, and publishes the public data d21. Then, the data management device 100a transmits a public data d21 to the data management device 100 in an area other than area a, such as the data management device 100b1 in area b1 or the data management device 100b2 in area b2. When the data management device 100b1 in area b1 receives a public data d21, the data management device 100b1 generates and publishes a public data d22 to share in area b1. As described above, each data management device 100 that receives a public data d21 generates and publishes a public data d2i to share in the area where the data management device 100 exists. The user terminal 2 can access and retrieve the public data d2i published on the data management device 100 and user terminal 2 can make the data management device 100 generate modified data by applying the prescribed modify processing to the public data d2i.

Here, the control plane 200 transmits, to the data management device 100, information relating to modify processing to be added to the original data d1 in order for the data management device 100 to generate the public data d2i. The data management device 100 generates the public data based on the information transmitted from the control plane 200.

The original data d1 and the public data d2i processed from the original data d1 are distributed and stored at a plurality of geographically separated points. The original data and the public data can be considered as a type of geographically distributed data in which the same type of data is distributed and stored at a plurality of geographically separated points. The user terminal 2 can obtain the public data d2i by accessing the data management device 100 in the area where the user terminal 2 exists. The user terminal 2 is prevented from accessing the data management device 100 in the area where the user terminal 2 does not exist.

### <<System Configuration of Data Sharing System 1>>

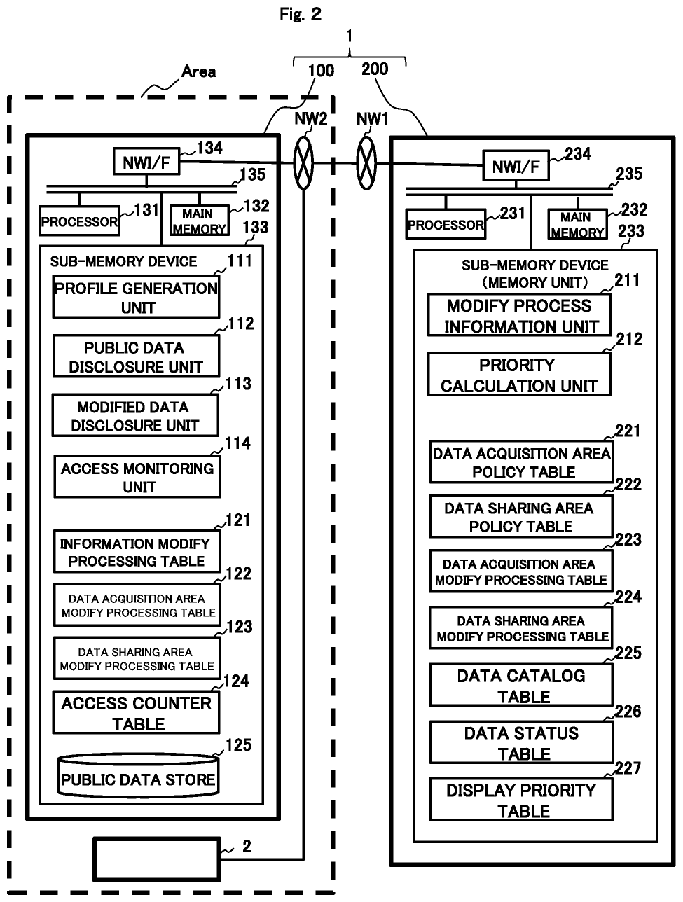

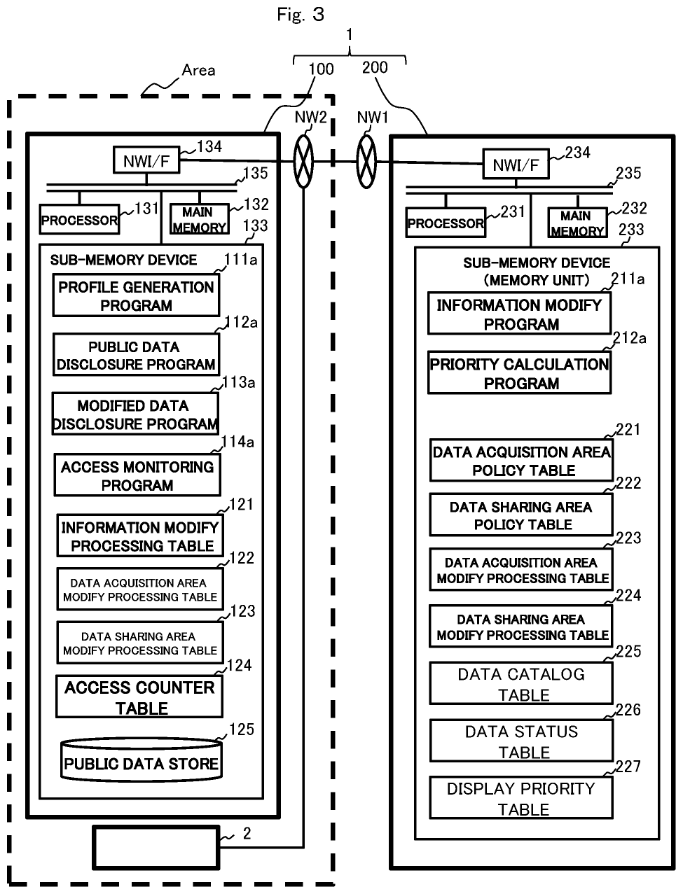

Next, the structure of data sharing system 1 is explained with reference to FIG. 2 and FIG. 3. FIG. 2 is a diagram showing an example of a function block diagram of the data sharing system of Example. And FIG. 3 is a block diagram showing an example of a hardware configuration of the data sharing system of Example.

### <Configuration of Data Management Device 100>

As shown in FIG. 2, the data management device 100 has a functional configuration including a profile generation unit 111, a public data disclosure unit 112, a modified data disclosure unit 113, and a number of times of access monitoring unit 114. As shown in FIG. 3, the data management device 100 has a hardware configuration including a processor 131, a main memory device 132, a sub-memory device 133, an NWI/F (Interface) 134, and a bus 135 for connecting these components. The data management device 100 can be realized by a general information processing apparatus such as a general server apparatus.

The processor 131 controls each unit of the data management device 100, reads out the data and programs stored in the sub-memory device 133 to the main memory device 132, and executes processing determined by the programs. The profile generation unit 111 is realized by the processor 131 reading out the profile generation program 111a stored in the sub-memory device 133 to the main memory device 132 and executing the program. The public data disclosure unit 112 is realized by the processor 131 reading out the public data disclosure program 112a stored in the sub-memory device 133 to the main memory device 132 and executing the program. The modified data disclosure unit 113 is realized by the processor 131 reading out the modified data disclosure program 113a stored in the sub-memory device 133 to the main memory device 132 and executing the program. The number of times of access monitoring unit 114 is realized by the processor 131 reading out the number of times of access monitoring program 114a stored in the sub-memory device 133 to the main memory device 132 and executing the program. In this specification, when the processing is described in a sentence whose subject is the profile generation unit 111, the public data disclosure unit 112, the modified data disclosure unit 113, and the number of times of access monitoring unit 114, it indicates that the processor 131 of the data management device 100 executes the profile generation program 111a, the public data disclosure program 112a, the modified data disclosure program 113a, and the number of times of access monitoring program 114a that realize the functional unit.

The main memory device 132 is a RAM or the like, includes a volatile memory element, and stores programs executed by the processor 131, and data.

The sub-memory device 133 is an HDD (Hard Disk Drive), SSD (Solid State Drive), or the like, which has a nonvolatile storage element and stores programs, data, and the like. The sub-memory device 133 stores the profile generation program 111a, the public data disclosure program 112a, the modified data disclosure program 113a, the number of times of access monitoring program 114a, the information modify processing table 121, the data acquisition area modify processing table 122, the data sharing area modify processing table 123, the access counter table 124 and the public data store 125.

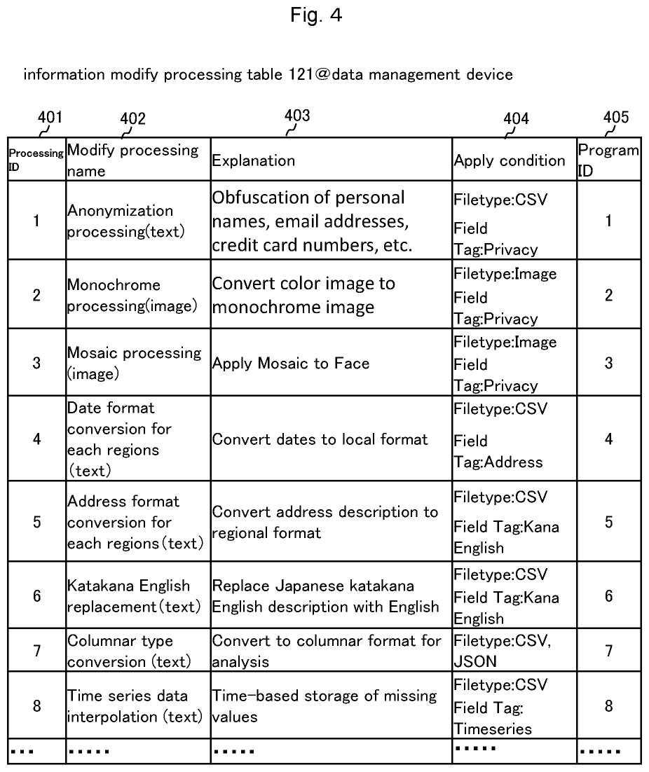

The information modify processing table 121, which will be described in detail below with reference to FIG. 4, stores information about programs that modify data.

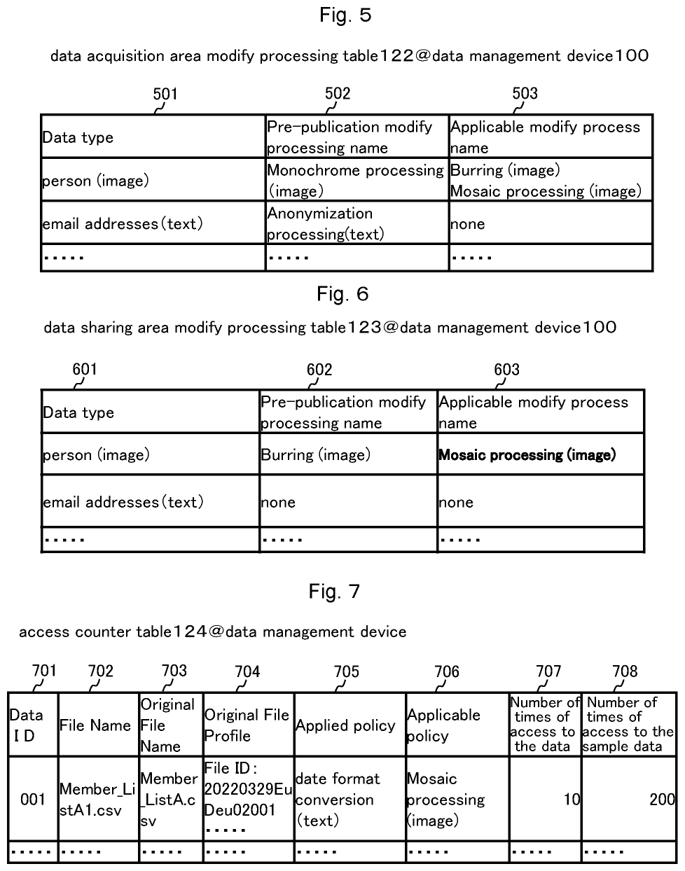

The data acquisition area modify processing table 122, which will be described in detail later with reference to FIG. 5, stores information about modify processing to be applied to data in order to generate public data of the data acquisition area where the original data is acquired.

The data sharing area modify processing table 123, which will be described in detail below with reference to FIG. 6, stores information about the modify processing to be applied to the data to generate public data of the data sharing area.

The access counter table 124, which will be described in detail later with reference to FIG. 7, stores information about the number of times of access to the published data by the user terminal 2.

The public data store 125 stores public data.

The sub-memory device 133 has installed therein the profile generation program 111a, the public data disclosure program 112a, the modified data disclosure program 113a and the number of times of access monitoring program 114a. As described above, the profile generation program 111a, the public data disclosure program 112a, the modified data disclosure program 113a and the number of times of access monitoring program 114a are programs that are executed by the processor 131 to realize the functions of the profile generation unit 111, the public data disclosure unit 112, the modified data disclosure unit 113, and the number of times of access monitoring unit 114, respectively.

The NWI/F 134 is connected to the network NW2, and is an interface (transmitting and receiving device) capable of transmitting and receiving data to and from a device such as the data management device 100 in the area other than the area where the data management device 100 is located, the control plane 200, or the user terminal 2, via the network NW1 and NW2. Using NWI/F 134, the data management device 100 can to transmit and receive data to and from devices such as the data management device 100 in the area other than the area where the data management device 100 is located, the control plane 200, or the user terminal 2, via the network NW1 and NW2.

<Configuration of Control Plane 200>

As shown in FIG. 2, the control plane 200, has a functional configuration including a modify process information unit 211 and a priority calculation unit 212. And, as shown in FIG. 3, the control plane 200 has, as a hardware configuration, a processor 231, a main memory device 232, a sub-memory device 233, an NWI/F 324, and a bus 325 for connecting them, similarly to the data management device 100. The control plane 200 can be realized by a general information processing apparatus such as a general server apparatus, similarly to the data management device 100.

The sub-memory device 233 stores an information modify program 211a, a priority calculation program 212a, a data acquisition area policy table 221, a data sharing area policy table 222, a data acquisition area modify processing table 223, a data sharing area modify processing table 224, a data catalog table 225, a data status table 226, and a display priority table 227.

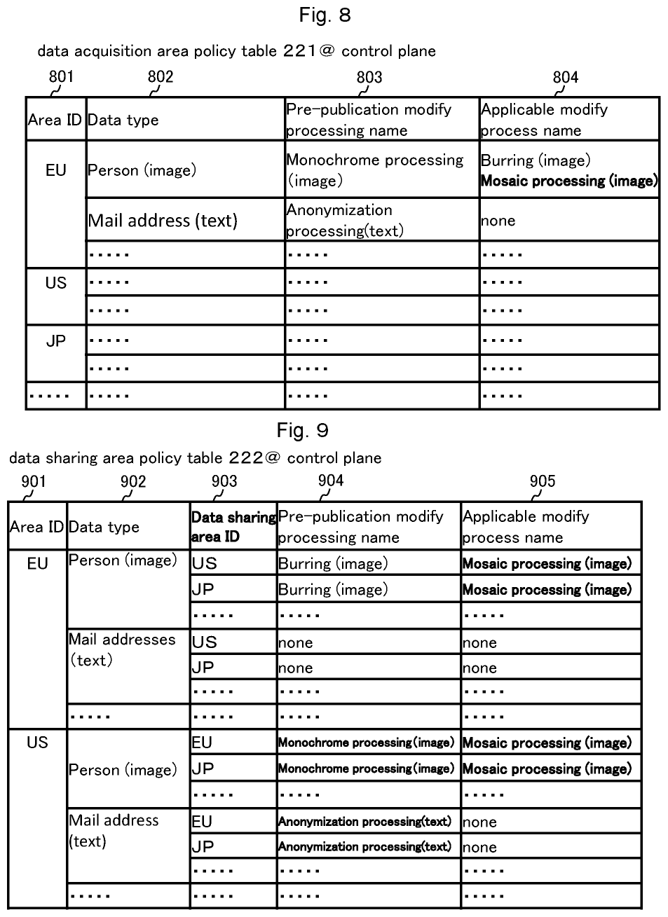

The data acquisition area policy table 221, which will be described in detail later with reference to FIG. 8, stores information about modify processing to be applied to the original data in the area where the data management device 100 that has acquired the original data exists.

The data sharing area policy table 222, which will be described in detail later with reference to FIG. 9, stores information relating to modify processing to be applied to data to generate public data in an area other than the data acquisition area where the data management device 100 that has acquired the original data exists.

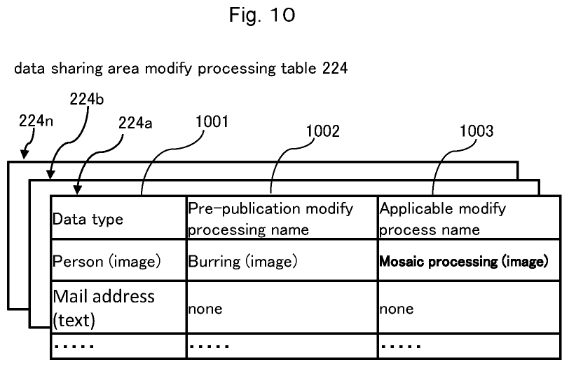

The data sharing area modify processing table 224, which will be described in detail later with reference to FIG. 10, stores information which is about modify processing to be applied to data in order to generate public data in an area other than the area where the data management device 100 that acquired the original data exists, and which is generated after the control plane 200 acquires information about the original data.

The data catalog table 225 stores information about the public data stored in each of the data management devices 100.

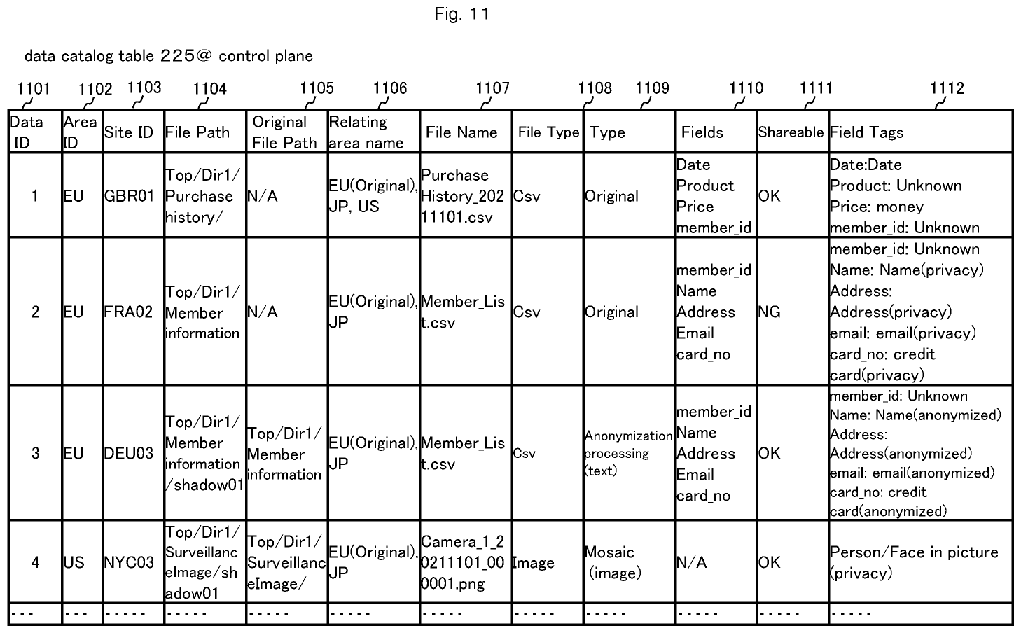

The data status table 226, which will be described in detail later using FIG. 11, stores information on the usage of public data in each area.

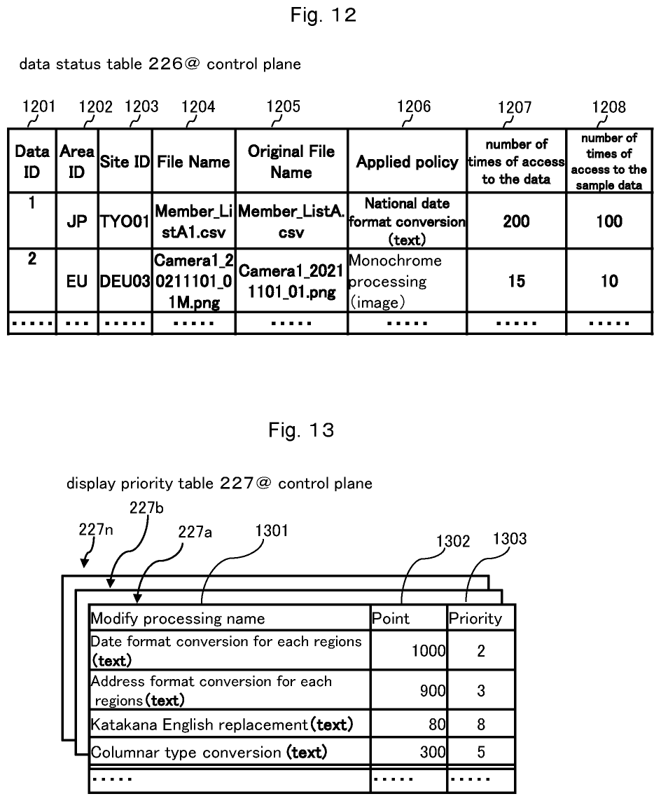

The display priority table 227, which will be described in detail later with reference to FIG. 12, stores information about the priority of display of name of the modify processing which can be applied to the public data and modified data stored in the data management device 100.

The sub-memory device 233 has installed therein the information modify program 211a and the priority calculation program 212a. Each of the modify process information unit 211 and the priority calculation unit 212 are realized by the processor 231 reading out each of the information modify program 233a and the priority calculation program 212a stored in the sub-memory device 233 to the main memory device 232 and executing them. The information modify program 211a and the priority calculation program 212a are executed by the processor 231 to realize the functions of the modify process information unit 211 and the priority calculation unit 212, respectively.

In this specification, when the processing is described in a sentence whose subject is the modify process information unit 211 and the priority calculation unit 212, it indicates that the processor 231 of the control plane 200 executes the information modify program 211a and the priority calculation program 212a that realize the functional unit.

<<Data Configuration of Data Sharing System 1>>

Next, the data configuration of various types of data used in the data sharing system 1 will be described with reference to FIG. 4 to FIG. 13.

FIG. 4 is a diagram showing an example of a information modify processing table 121. The information modify processing table 121 is stored in the data management device 100. The information modify processing table 121 has, as fields, a processing ID 401, a modify processing name 402, a explanation 403, an apply condition 404, and a program ID 405.

The processing ID 401 is an ID that identifies modify processing. The modify processing name 402 is the name of modify processing. The explanation 403 is the explanation of the contents of modify processing. The apply condition 404 is a condition for applying modify processing. The program ID 405 is the ID of the program that performs modify processing.

FIG. 5 is a diagram showing an example of a data acquisition area modify processing table 122. The data acquisition area modify processing table 122 is stored in the data management device 100. The data acquisition area modify processing table 122 has, as fields, a data type 501, a pre-publication modify processing name 502, and an applicable modify process name 503.

The data type 501 is the name of the type of data to which modify processing is to be applied. The pre-publication modify processing name 502 is the name of the modify processing to be applied to the original data. The applicable modify process name 503 is the name of the modify processing that can be applied to the public data (public data for data acquisition area d 21) generated by the data management device 00 that acquired the original data. Here the data management device 100 generated the public data by applying modify processing to the original data.

Note that, the data type 501 and the pre-publication modify processing name 502 are pre-publication modify processing information. The pre-publication modify processing information stores in association with each other, the name 501 of a pre-publication modify type of data to be modified before publication among types of data included in the original data (the data type 501) and the name 502 of a modify processing for modifying the data of the pre-publication modify type (the pre-publication modify processing name 502).

And, the data type 501 and the applicable modify process name 503 are the applicable modify process information. The applicable modify process information. The applicable modify process information stores, in association with each other, the name 501 of the applicable modify type of applicable modify data included in the public data (the data type 501), and the name 503 of the modify processing that can modify the data of applicable modify type (the applicable modify process name 503).

FIG. 6 is a diagram showing an example of a data sharing area modify processing table 123. The data sharing area modify processing table 123 is stored in the data management device 100. The data sharing area modify processing table 123 has, as fields, a data type 601, a pre-publication modify processing name 602, and an applicable modify process name 603.

The data type 601 is the name of the type of data to which modify processing is to be applied. The pre-publication modify processing name 602 is the name of the modify processing to be applied to the public data (public data for data acquisition area d21). The applicable modify process name 603 is the name of the modify processing applicable to the public data (public data for data sharing area d2n) created by applying modify processing to the public data (public data for data acquisition area d21).

Note that, the data type 601 and the pre-publication modify processing name 602 are pre-publication modify processing information. The pre-publication modify processing information stores in association with each other, the name 601 of a pre-publication modify type of data to be modified before publication among types of data included in the original data (the data type 601) and the name 602 of a modify processing for modifying the data of the pre-publication modify type (the pre-publication modify processing name 602).

And, the data type 601 and the applicable modify process name 603 are the applicable modify process information. The applicable modify process information. The applicable modify process information stores, in association with each other, the name 601 of the applicable modify type of applicable modify data included in the public data (the data type 601), and the name 603 of the modify processing that can modify the data of applicable modify type (the applicable modify process name 603).

FIG. 7 is a diagram showing an example of the access counter table 124. The access counter table 124 is stored in the data management device 100. The access counter table 124 has, as fields, a data ID 701, a file name 702, an original file name 703, an original file profile 704, applied policies 705, applicable policies 706, the number of times of access to the data 707, and a number of times of access to the sample data 708.

The data ID 701 is an ID for identifying the modified data generated by applying the modify processing to the public data stored in the data management device 100. The file name 702 is a file name of the modified data. The original file name 703 is the original data (public data or modified data) from which the modified data is generated. The data management device 100 generates the modified data by applying the modify processing to the original data (public data or modified data). The original file profile 704 is the profile of the original data d1 described later, which includes the information of the type of the data included in the original data (public data). The applied policies 705 is the name of the modify processing applied to the modified data. The applicable policies 706 is the name of the modify processing applicable to the modified data. The number of times of access to the data 707 is the number of times user terminals 2 has accessed the modified data. The number of times of access to the sample data 708 is the number of times user terminals 2 has accessed the sample data of modified data, which will be described later.

FIG. 8 is a diagram showing an example of a data acquisition area policy table 221. The data acquisition area policy table 221 is stored in the control plane 200. The data acquisition area policy table 221 has, as fields, an area ID 801, a data type 802, a pre-publication modify processing name 803, and an applicable modify process name 804.

The area ID 801 is an ID for identifying the area and is a name of the area. The data type 802 is the type of modifiable data that the original data may contain. The pre-publication modify processing name 803 is the name of the modify processing to be applied before publication to the data that may be included in the original data d1 and for which the modify processing needs to be applied before publication. The applicable modify process name 804 is a name of modify processing that can apply to the public data (public data for data acquisition area d21) generated by processing the original data d1.

FIG. 9 is a diagram showing an example of a data sharing area policy table 222. The data sharing area policy table 222 is stored in the control plane 200. The data sharing area policy table 222 has, as fields, an area ID 901, a data type 902, a data sharing area ID 903, a pre-publication modify processing name 904, and an applicable modify process name 905. The area ID 901 is an ID for identifying the area and is a name of the area. The data type 902 is the type of modifiable data that the original data may contain. The data sharing area ID 903 is the ID for identifying the area (sharing area). The pre-publication modify processing name 904 is the name of the modify processing to be applied before publication to the data that may be included in the original data d1 and for which the modify processing needs to be applied before publication. The applicable modify process name 905 is a name of modify processing that can apply to the public data (the public data for data acquisition area d21) generated by processing the original data d1.

The pre-publication modify processing name 904 is the name of the modify processing to be applied before publication to the data that is included in the original data d1 and for which the modify processing needs to be applied before publication in the sharing area, which will be described later.

The data configuration of the data acquisition area modify processing table 223 stored in the control plane 200, is similar to the data configuration of the data acquisition area modify processing table 122 stored in the data management device 100 described with reference to FIG. 5. Description of the data configuration of the data acquisition area modify processing table 223 is omitted.

FIG. 10 is a diagram showing an example of a data sharing area modify processing table 224.

The data sharing area modify processing table 224 is stored in control plane 200. The data sharing area modify processing table 224 consists of data sharing area modify processing tables 224a-224n generated for each area. The data configuration of each of the data sharing area modify processing tables 224a-224n, is similar to the data configuration of the data sharing area modify processing table 223 stored in the data management device 100 described with reference to FIG. 6. Description of the data configurations of the data sharing area modify processing tables 224a-224n is omitted. Each of the data sharing area modify processing tables 224a-224n has, as fields, a data type 1001, a pre-publication modify processing name 1002, and an applicable modify process name 1003.

FIG. 11 is a diagram showing an example of a data catalog table 225. The data catalog table 225 is stored in the control plane 200. The data catalog table 225 has, as fields, a data ID 1101, an area ID 1102, a site ID 1103, a file path 1104, an original file path 1105, a relating area name 1106, a file name 1107, a file type 1108, a file species 1109, a field 1110, a shareable 1111, and a field tag 1112.

The data ID 1101 is an ID for identifying the data (original data, public data, and modified data) stored in the data management device 100. The area ID 1102 is an ID for identifying the area in which the data is stored and is the name of the area. The site ID 1103 is an ID for identifying the data management device 100 in which the data is stored. The file path 1104 is a location where the data is stored in the data management device 100. The original file path 1105 is a location where the original data of the data is stored, and “N/A” is stored in the original file path 1105 when the data is the original data. The relating area name 1106 is the area in which the family of data (original data, its public data and its modified data) is stored. The file name 1107 is the file name of the data. The file type 1108 is the format of the data. The file species 1109 is the type of data (original data, public data, or modified data modified from public data). The field 1110 is a list of types of data included in the data. The shareable 1111 is whether the data is disclosed to the public. The field tag 1112 is the tag attached to the data.

FIG. 12 is a diagram showing an example of a data status table 226. The data status table 226 is stored in the control plane 200. The data status table 226 has, as fields, a data ID 1201, an area ID 1202, a site ID 1203, a file name 1204, an original file name 1205, applied policies 1206, a number of times of access to the data 1207, and a number of times of access to the sample data 1208.

The data ID 1201 is an ID for identifying the modified data stored in the data management device 100. The area ID 1202 is an ID for identifying the area in which the data management device 100 storing the modified data exists and is the name of the area. The site ID 1103 is an ID for identifying the data management device 100 storing the modified data. The file name 1107 is the file name of the modified data. The original file name 1205 is the name of original data (public data or modified data) from which the modified data is generated. The data management device 100 generate modified data by applying modify processing to data of original (public data or modified data). The applied policies 1206 is the name of the modify processing applied to the modified data. The number of times of access to the data 1207 is the number of times user terminals 2 has accessed the modified data. The number of times of access to the sample data 1208 is the number of times user terminals 2 has accessed the sample data of modified data, which will be described later.

FIG. 13 is a diagram showing an example of a display priority table 227. The display priority table 227 is stored in control plane 200. The display priority table 227 consists of the display priority tables 227a-227n generated for each area. As an example, the display priority table 227a has, as fields, a modify processing name 1301, a points 1302 and a priority 1303.

The modify processing name 1301 is the name of modify processing. The points 1302 is the points for modify processing. The priority 1303 is the display priority of the modify processing name when the user terminal 2 displays the name of modify processing applicable to the data to be disclosed (public data and modified data).

<<Processing Procedure>>

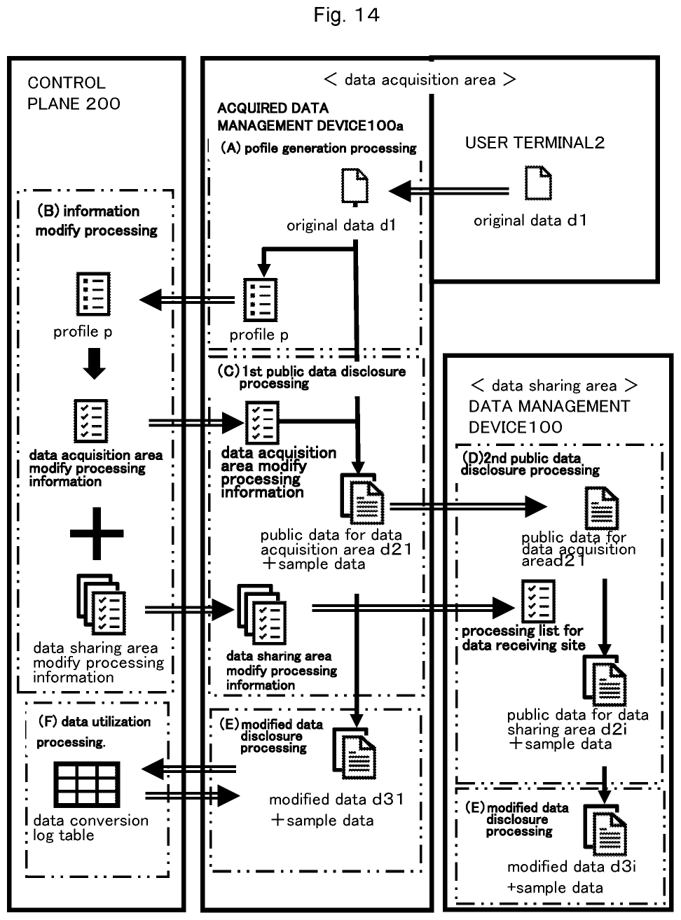

Next, the outline of the processing procedure of the data sharing system 1 will be described with reference to FIG. 14.

FIG. 14 is an explanatory diagram showing an outline of processing of the data sharing system 1. The user terminal 2 transmits the original data d1 to the data management device 100 in the same area as the user terminal 2. The data management device 100 acquires the original data d1 by receiving the original

An area where the data management device 100 that acquired the original data d1 exists is defined as a data acquisition area. An area other than the data acquisition area is defined as a sharing area. The data management device 100 that receives the original data d1 is defined as an acquired data management device 100a.

When the acquired data management device 100a acquires the original data d1, the data sharing system 1 executes, (A) profile generation processing, (B) information modify processing, (C) first public data disclosure processing, (D) second public data disclosure processing, and (E) modified data disclosure processing to publish the public data generated from the original data d1. Furthermore, the data sharing system 1 executes (F) public data and modified data utilization processing.

(A) profile generation processing; When the acquired data management device 100a acquires the original data d1, the profile generation unit 111 of the acquired data management device 100a executes profile generation processing. The profile generation unit 111 generates profile p including information of the data acquisition area where the original data d1 are acquired, and a list of types of data included in the original data d1. The profile generation unit 111 further transmits the profile p to the control plane 200.

(B) information modify processing; When the control plane 200 receives the profile p, the modify process information unit 211 of the control plane 200 executes information modify processing. In the information modify processing, the modify process information unit 211 generates, for each of the plurality of areas, pre-publication modify processing information storing, in association with each other, the name of a pre-publication modify type of data to be modified before publication among types of data included in the original data d1 and the name of a modify processing for modifying the data of the pre-publication modify type. Here, the modify process information unit 211 generates pre-publication modify processing information based on the profile p, the data acquisition area policy table 221, and the data sharing area policy table 222.

There are two types of the pre-publication modify processing information, the data acquisition area modify processing table 223 (modify processing information for the acquisition area) for the data acquisition area, and the data sharing area modify processing table 224 (modify processing information for the sharing area) for each of the sharing areas. The modify process information unit 211 transmits the data acquisition area modify processing table 223 and the data sharing area modify processing table 224, to the acquired data management device 100a in the data acquisition area.

(C) first public data disclosure processing; When the acquired data management device 100a receives and acquires pre-publication modify processing information (a part of the data acquisition area modify processing table 223 and a part of the data sharing area modify processing table 224), in the first public data disclosure processing, the public data disclosure unit 112 of the acquired data management device 100a generates the public data for data acquisition area d21 and its sample data d21s, by modifying the original data d1 with the data modify processing, based on the data acquisition area modify processing table 223, and the public data disclosure unit 112 stores the public data for data acquisition area d21 and its sample data d21s in the acquired data management device 100a. The public data disclosure unit 112 of the acquired data management device 100a publishes the public data for data acquisition area d21 and its sample data d21s, to the user terminal 2.

In addition, the public data disclosure unit 112 of the acquired data management device 100a transmits the profile p and the data sharing area modify processing table 224i (data sharing area modify processing information) to the data management device 100 of each of the sharing areas. In each of the sharing areas, when the data management device 100 receives the profile p and the data sharing area modify processing table 224i, the data management device 100 requests the acquired data management device 100a for the public data for data acquisition area d21, and acquires the public data for data acquisition area d21 from the acquired data management device 100a.

(D) second public data disclosure processing; In each of the sharing areas, when the data management device 100 acquires the public data for data acquisition area d21, the public data disclosure unit 112 of the data management device 100 executes the second public data disclosure processing. In the second public data disclosure processing, the public data disclosure unit 112 generates the public data for data sharing area d2i and its sample data d2is, by modifying the public data for data acquisition area d21 with the data modify processing, based on the sharing area processing table 224i (data sharing area modify processing information), and the public data disclosure unit 112 stores the public data for data sharing area d2i and its sample data d2 is in the data management device 100. The public data disclosure unit 112 of the data management device 100 publishes the public data for data sharing area d2i and its sample data d2is, to the user terminal 2.

As described above, the acquired data management device 100a generate the public data for data acquisition area d21 by modifying the original data d1 with the data modify processing. Further, the data management device 100 generate the public data for data sharing area d2i by modifying the public data for data acquisition area d21 with the data modify processing. Therefore, the public data for data sharing area d2i is the data obtained by modifying the original data d1 with the data modify processing.

(E) modified data disclosure processing; The data management device 100, including the acquired data management device 100a and the data management device 100 in the sharing area, in the modified data disclosure processing, generates modified data by applying modify processing to the public data and modified data.

(F) public data and modified data utilization processing; To the accessed user terminal 2, the data management device 100 (the acquired data management device 100a or the data management device 100 in the sharing area) publishes public data (public data for data acquisition area d21 or public data for data sharing area d2i, and their modified data). The data management device 100 presents the user terminal 2 with a list of the name (applicable modify processing name) of modify processing applicable to the public data. Here, the control plane 200 calculates the priority of the display of the applicable modify process name in this list, and the data management device 100 transmits the list in which the applicable modify process names are sorted based on the calculated priority, to the user terminal 2. While the outline of the processing procedure of the data sharing system 1 has been described above, the details of each processing will be described below.

<(A) Profile Generation Processing>

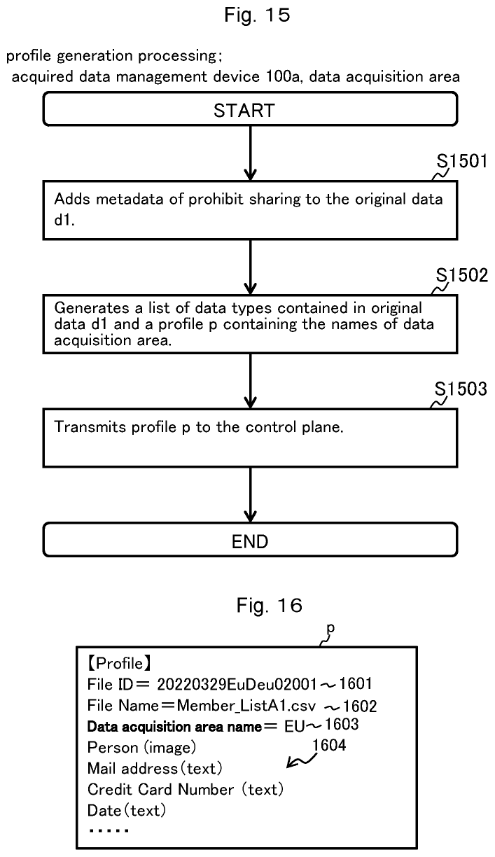

FIG. 15 is a flowchart showing an example of the profile generation processing of Example. As described above, when the user terminal 2 transmits the original data d1 to the acquired data management device 100a in the data acquisition area, the profile generation unit 111 of the acquired data management device 100a executes the profile generation processing.

The acquired data management device 100a adds metadata indicating that sharing is prohibited to the original data d1 (step 1501).

Next, the acquired data management device 100a analyzes the type of the data included in the original data d1, and generates a profile p including the data acquisition area name (information of the data acquisition area) and a list of the types of the data included in the original data d1 (step 1502).

FIG. 16 is a diagram showing an example of a profile p. As shown in FIG. 16, the profile p includes file ID 1601, file name 1602, data acquisition area name 1603, and a list 1604 of file types of the original data d1. The file ID 1601 are, for example, 20220329EuDeu02001. In the example of this example file ID, “20220329” is the date of acquisition of the original data d1. “EU” is the data acquisition area name. “Deu02” is identification information for identifying the acquired data management device 100a. “001” is the ID of the original data d1 in the acquired data management device 100a. In the example of the profile p in FIG. 16, the type of data included in the original data d1 includes a person's image, e-mail address, and credit card number.

Next, the acquired data management device 100a transmits the profile p to the control plane 200 using the NWI/F 134, and ends the processing (step 1503).

<(B) Information Modify Processing>

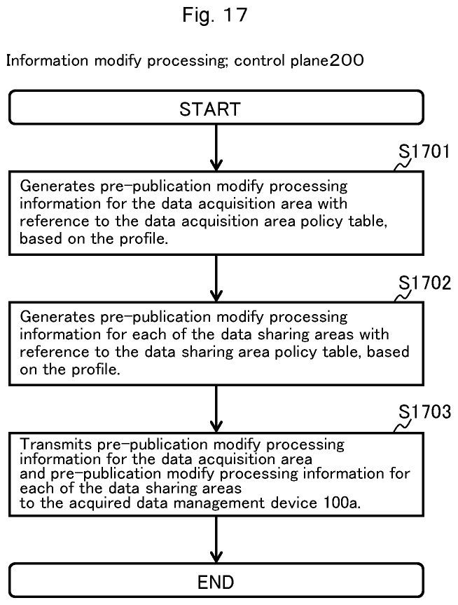

FIG. 17 is a flowchart showing an example of the information modify processing of Example. When the control plane 200 receives the profile p from the data management device 100a, the control plane 200 stores the information of the original data d1 in the data catalog table 225. And the modify process information unit 211 of the control plane 200 executes information modify processing.

The control plane 200 reads out the data acquisition area policy table 221 from the sub-memory device (memory unit) 233 and generates the data acquisition area modify processing table 223 with reference to the data acquisition area policy table 221, based on the profile p (step S1701).

Here, the data acquisition area modify processing table 223 includes pre-publication modify processing information for the data acquisition area and applicable modify process information for the data acquisition area. The pre-publication modify processing information stores, in association with each other, the type of data to be modified in the data acquisition area (pre-publication modify type) among the types of data included in the original data d1 and the name of the modify processing for modifying the data of the pre-publication modify type. The applicable modify process information stores, in association with each other, the type of applicable modify data (applicable modify type) in the public data for data acquisition area d21 generated from the original data d1 and the name (information) of modify processing for the data of the applicable modify type.

In step 1701, the control plane 200 acquires the pre-publication modify processing name and the applicable modify process name, associated with the area ID of the data acquisition area included in the profile p and the type name of the data, from the data acquisition area policy table 221 (see FIG. 8). And the control plane 200 generates pre-publication modify processing information for the data acquisition area and applicable modify process information with associating the type name of the data with the acquired pre-publication modify processing name and applicable modify process name.

Here, in the data acquisition area modify processing table 223 (see FIG. 5), the type of data (data type) and pre-publication modify processing name are pre-publication modify processing information. The type of data (data type) and applicable modify process name are applicable modify process information.

Next, the control plane 200 reads out the data sharing area policy table 222 from the sub-memory device (memory unit) 233 and generates the data sharing area modify processing table 224 (see FIG. 10) for each of the data sharing areas with reference to the data sharing area policy table 222, based on the profile p (step S1702). Here, the control plane 200 generates a data sharing area modify processing table 224 (see FIG. 10) for each data sharing area, for example, as follows. The control plane 200 extracts all the records (referred to as the acquisition area records) related to the area ID 901 of the data acquisition area included in the profile p from the data sharing area policy table 222. The control plane 200 extract all pairs of the type name 902 of the data included in the profile p, the data sharing area ID associated with the type name 902 of the data included in the profile p, the pre-publication modify processing name 904 and the applicable modify process name from the acquired area records. The control plane 200 collect the pairs with the same data sharing area ID 903 (For example, the pairs whose data sharing area ID 903 are US) and collected into a table from all the extracted pairs, and the collected table is defined as a data sharing area modify processing table 224.

As shown in FIG. 10, the data sharing area modify processing table 224 stores, in association with each other, data type, pre-publication modify processing information for the data sharing area, and applicable modify process information for the data sharing area. The pre-publication modify processing information is the type of data to be processed in the data sharing area (pre-publication modify type. In the data sharing area modify processing table 224 of FIG. 10, the field of data type 1001) and the pre-publication modify processing name (the field of pre-publication modify processing name 1002 in the data sharing area modify processing table 224 of FIG. 10), which is the name of the modify processing for processing the data of the pre-publication modify type, are stored in association with each other. The applicable modify process information is generated from the public data for data acquisition are d21 and is stored in the public data for data sharing are d2i published in the data sharing area by associating the type of applicable modify data (applicable modify type, field of data type 1001 in the data sharing area modify processing table 224 in FIG. 10) with the applicable modify process name (field of applicable modify process name 1003 in the data sharing area modify processing table 224 in FIG. 10), which is the name of the modify processing for the data of the applicable modify type.

In the data sharing area policy table 222, the data sharing area ID 903 is not stored, and the data sharing area ID 903 cannot be associated with the type name of the data included in the original data d1. In other words, in the data sharing area policy table 222, for the area in which the data sharing area ID associated with the type of the data included in the original data d1 is stored, the data sharing area modify processing table can be generated, and thus the public data for data sharing area 2 n can be generated. On the other hand, in the data sharing area policy table 222, for the area in which the data sharing area ID is not stored in the line of the type of the data included in the original data d1, the data sharing area modify processing table is not generated, and thus the public data for data sharing area 2 I is not generated from the original data d1.

Next, the control plane 200 transmits the data acquisition area modify processing table 223 and the data sharing area modify processing table 224 for each of the data sharing areas to the acquired data management device 100a, and ends the processing (step 1703).

<(C) First Public Data Disclosure Processing of Acquired Data Management Device 100 a>

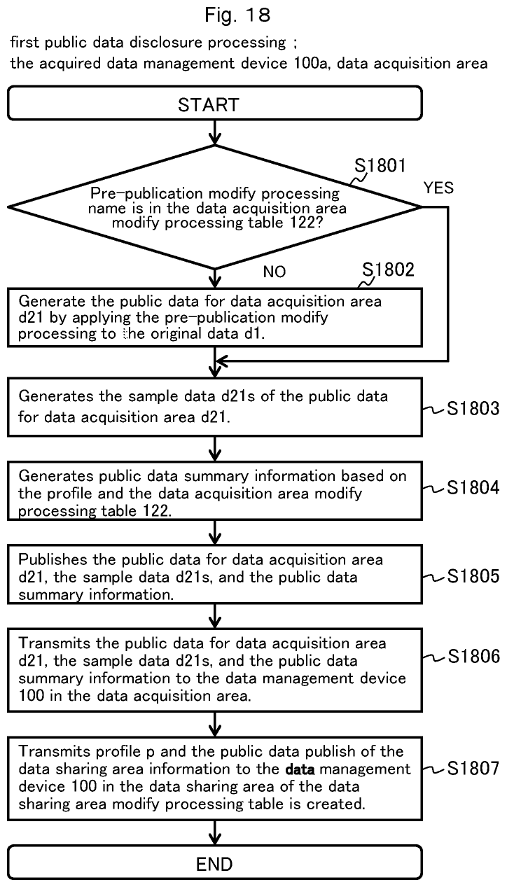

FIG. 18 is a flowchart showing an example of first public data disclosure processing of Example. When the data management device 100a receives the data acquisition area modify processing table 223 and the data sharing area modify processing table 122 for each data sharing area from the control plane 200, the data management device 100a overwrites and saves the data acquisition area modify processing table 223 to the data acquisition area modify processing table 224, and the public data disclosure unit 112 of the data management device 100a executes the first public data disclosure processing.

The acquired data management device 100a determines whether there is a pre-publication modify processing name in the data acquisition area modify processing table 122 (step S1801). When it is determined that there is a pre-publication modify processing name in the data acquisition area modify processing table 122 (step S1801: YES), the process proceeds to step S1802. On the other hand, when it is determined that there is no pre-publication modify processing name (step S1801: NO), a copy of the original data d1 is stored as public data for data acquisition area d21 without processing, and the process proceeds to step S1803.

Next, the acquired data management device 100a uses the information modify processing table 121 to apply the pre-publication modify processing associated with the pre-publication modify processing name stored in the data acquisition area modify processing table 122 to the original data d1 to generate the public data for data acquisition area d21 (step 1802). Here, the acquired data management device 100a first refers to the data acquisition area modify processing table 122 to acquire the program ID (program ID of the program of the pre-publication modify processing) associated with the pre-publication modify processing name stored in the data acquisition area modify processing table 122.

Next, the acquired data management device 100a executes the modify processing program associated with the acquired program ID to generate the public data for data acquisition area d21 by applying the pre-publication processing to the original data d1.

Next, the acquired data management device 100a generates the sample data d21s of the public data for data acquisition area d21 (step 1803). In the generation of the sample data, if the type is text data (address, mail address, etc.) among the data included in the public data for data acquisition area d21, the acquired data management device 100a generates the sample data by extracting the data at random. If the type is image data (face photo), the acquired data management device 100a generates a thumbnail of the image and sets the generated thumbnail as the sample data.

Next, the acquired data management device 100a generates public data summary information based on the data acquisition area modify processing table 122 and the profile p (step 1804). Here, the acquired data management device 100a generates applicable modify process information that associates and stores the name of the applicable modify type of the applicable modify data and the applicable modify process name representing the name of the modify processing that can process the data of the applicable modify type, among the data included in the public data for data acquisition area d21.

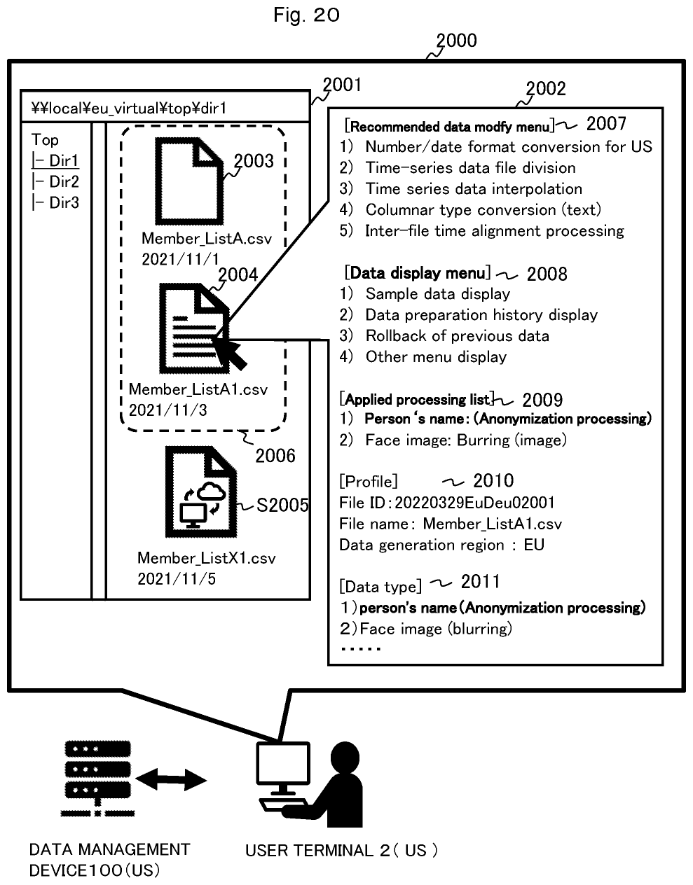

The public data summary information includes information (see FIG. 20) to be transmitted to and displayed on the user terminal 2 that has accessed the public data for data acquisition area d21. That is, the public data summary information includes applicable modify process information, and the public data summary information includes information on the data type of the public data for data acquisition area d21, information on the applicable modify process name and profile p included in the data acquisition area modify processing table 122, and the like. The public data summary information is information included in the data viewing screen 2000 including the public file operation menu, which will be described later using FIG. 20.

Next, the acquired data management device 100a stores the public data for data acquisition area d21, the sample data d21s, and the public data summary information in the public data store 125, and publishes them (step 1805).

Next, the acquired data management device 100a transmits the public data for data acquisition area d21, the sample data d21s, and the public data summary information to the data management device 100 in the data acquisition area (step 1806). When the data management device 100 in the data acquisition area receives the public data for data acquisition area d21, the sample data d21s, and the public data summary information, it publishes these pieces of information in the same manner as the acquired data management device 100a.

Next, the acquired data management device 100a transmits public data publish of the data sharing area information, profile p, and the data sharing area modify processing table 224 i corresponding to the sharing area of the destination to the data management device 100 for each sharing area, and ends the processing (step 1807). Here, the public data publish of the data sharing area information is information including the fact that the acquired data management device 100a has disclosed the public data for data acquisition area d21.

When the data management device 100 of the data sharing area receives the public data publish of the data sharing area information, the profile p, and the data sharing area modify processing table, the data management device 100 transmits the public data for data acquisition are request information including a request for the public data for data acquisition are 21 to the acquired data management device 100a. When the acquired data management device 100a receives the public data for data acquisition are request information, the acquired data management device 100a transmits the public data for data acquisition are 21 to the data management device 100 that transmitted the public data for data acquisition are request information.

<(D) Second Public Data Disclosure Processing of Data Management Device 100 in Data Sharing Area>

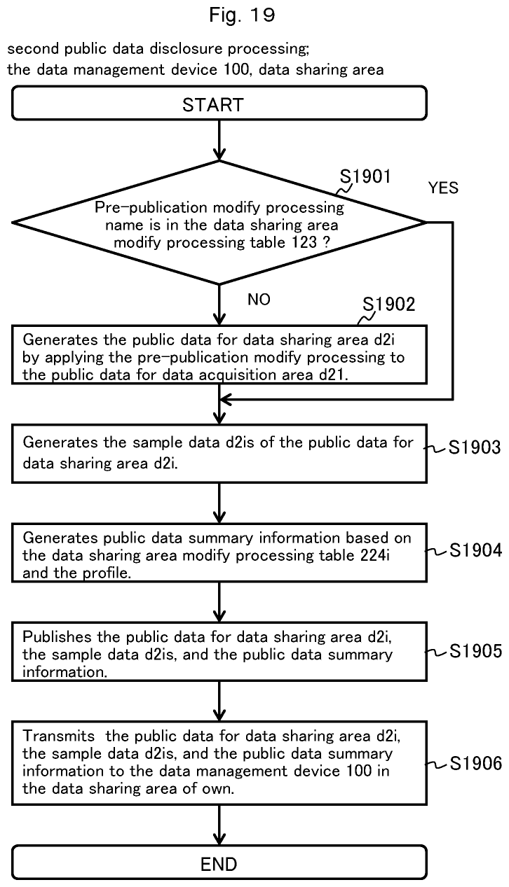

FIG. 19 is a flowchart showing an example of second public data disclosure processing of Example. When the data management device 100 of the data sharing area receives the public data for data acquisition area d21 from the data management device 100a, the data management device 100 overwrites and stores the data sharing area modify processing table 224i in the data sharing area modify processing table 123, and generates data reception information indicating that the public data for data acquisition area d21 has been received. The data reception information is data indicating that public data (public data for data sharing area d2i) regarding the original data d1 is being created. The data reception information is displayed as an icon (icon 2005 of the pre-publication data in FIG. 20) on the user terminal 2 that accesses the data management device 100. The public data disclosure unit 112 of the data management device 100 executes second public data disclosure processing.

The data management device 100 determines whether there is a pre-publication modify processing name in the data sharing area modify processing table 123 (step S1901). When it is determined that there is a pre-publication modify processing name in the data sharing area modify processing table 123 (step S1901: YES), the process proceeds to step S1902. On the other hand, when it is determined that there is no pre-publication modify processing name (step S1901: NO), a copy of the public data for data acquisition area d21 is stored as public data for data sharing area d2i without being processed, and the process proceeds to step S1903.

Next, the data management device 100 uses the data sharing area modify processing table 123 to apply the pre-publication modify processing associated with the pre-publication modify processing name stored in the data sharing area modify processing table 123 to the public data for data acquisition area d21 to generate public data for data sharing area d2i (step 1902). Here, the data management device 100 first refers to the data sharing area modify processing table 123 to acquire the program ID (program ID of the program of the pre-publication modify processing) associated with the pre-publication modify processing name stored in the data sharing area modify processing table 123. Next, the data management device 100 executes the modify processing program associated with the acquired program ID to generate public data for data sharing area d2i by applying the pre-publication processing to the public data for data acquisition area d21.

Next, the data management device 100 generates the sample data d21s of the public data for data sharing area d2i (step 1903). Here, the data management device 100 generates the sample data d2is of the public data for data sharing area d2i in the same manner as the sample data d21s of the public data for data acquisition area d21 (see step 1803 in FIG. 18).

Next, the data management device 100 generates public data summary information based on the processing list for the data sharing area (the data sharing area modify processing table 224i) and the profile p (step 1904). Here, the data management device 100 generates applicable modify process information that associates and stores the name of the applicable modify type of the applicable modify data and the applicable modify process name representing the name of the modify processing that can process the data of the applicable modify type among the data included in the public data for data sharing area d2i.

The public data summary information includes information (see FIG. 20) to be transmitted to and displayed on the user terminal 2 that has accessed the public data for data sharing area d2i. That is, the public data summary information includes applicable modify process information, and the public data summary information includes information on the data type of the public data for data sharing area d2i, information on the applicable modify process name and profile p included in the data sharing area modify processing table 123, and the like. The public data summary information is information included in the data viewing screen 2000 including the public file operation menu, which will be described later using FIG. 20.

Next, the data management device 100 stores the public data for data sharing area d2i, the sample data d2is, and the public data summary information in the public data store 125 and discloses them (step 1905). Here, the data management device 100 deletes the data reception information indicating that the public data (public data for data sharing area d2i) concerning the original data d1 is being created, and stops the disclosure of the data reception information (disclosure of the icon).

Next, the data management device 100 sends the public data for data sharing are registration information regarding the public data for data sharing area d2i to the control plane 200, and ends the processing (step 1906). Upon receiving the public data for data sharing are registration information, the control plane 200 stores records regarding the public data for data sharing area d2i in the data catalog table 225 (see FIG. 11) and the data status table 226 (see FIG. 12). In addition, the data management device 100 stores records regarding the public data for data sharing area d2i in the access counter table 124.

<(E) Modified Data Disclosure Processing and (F) Public Data and Modified Data Utilization Processing>

In the data acquisition area or the sharing area, which is an area other than the data acquisition area, when the user operates the user terminal 2 and the user terminal 2 accesses the data management device 100, the data management device 100 transmits the data viewing screen information to the user terminal 2 including the information of the name of the public data that the user terminal 2 can acquire, where the public data is the public data for data acquisition area d21 or the public data for data sharing area d2i. When the user terminal 2 receives the data viewing screen information from the data management device 100, the user terminal 2 displays the data viewing screen including the icon of the public data on the user terminal 2.

FIG. 20 is an explanatory diagram showing a data viewing screen including the public file operation menu displayed on the user terminal. The example of the data viewing screen 2000 shown in FIG. 20 includes a public file display window 2001 and a public file operation menu 2002. The public file display window 2001 depicts an icon 2003 of public data, an icon 2004 of modified data, an icon 2005 of pre-publication data, and a group boundary line 2006.

As described below, the user can use the user terminal 2 to specify the modify processing to be applied to the public data and cause the data management device 100 to apply the specified modify processing to the public data to generate the modified data. Similarly, the user can specify the modify processing to be applied to the modified data and cause the data management device 100 to apply the modify processing to the modified data to generate the modified data. That is, the modified data is data generated by the user using the user terminal 2 to specify the modify processing to be applied and cause the data management device 100 to apply the specified modify processing to the public data or the modified data.

The file name is drawn below the icon 2003 of the public data to the icon 2005 of the pre-publication data. The icon 2005 of the pre-publication data is an icon representing data reception information representing that the public data (public data for data sharing area d2i) concerning the original data d1 is being created, and the cloud mark written on the icon indicates that the public data (public data for data sharing area d2i) concerning the original data d1 is being created. The group boundary line 2006 is a line surrounding the same public data and modified data with the original data d1 of the generation source. In the example of FIG. 20, the group boundary line 2006 represents that the public data indicated by the icon 2003 and the modified data indicated by the icon 2004 are generated from the same original data d1.

As shown in FIG. 20, the public file operation menu 2002 includes a recommended modifying menu 2007, a data display menu 2008, a list of applied modify processes 2009, a profile 2010, and a data type 2011 relating to the public file (hereinafter referred to as right-click data) specified by the user by right-clicking the icon of the public file (public data or modified data) in the data viewing screen. The recommended modifying menu 2007 is a list of modify processing names (applicable modify process names) applicable to the right-click data. As described later, the data management device 100 generates modified data obtained by performing data processing on the row selected by the user in the recommended modifying menu 2007, and discloses the modified data.

The data display menu 2008 is a list of data relating to the right-click data. The data management device 100 transmits the data for the row selected by the user in the data display menu 2008 to the user terminal 2, and the user terminal 2 presents the received data to the user.

List of applied modify processes 2009 is a list of names of modify processing applied to the right-click data, profile 2010 is the profile of the right-click data, and data type 2011 is a list of types of data included in the right-click data.

(1) Access to a Public File and Counting of the Number of Accesses

When the user right-clicks the icon of the public file (public data or modified data) on the data viewing screen (see FIG. 20), the user terminal 2 transmits information indicating that the right-clicked public file (hereinafter referred to as right-click data) has been accessed to the data management device 100.

The data management device 100 generates public file operation information for the right-click data, and transmits the public file operation information to the user terminal 2. Further, the data management device 100 increments the value of the access count of the right-click data in the record of the right-click data by one in the access counter table 124. Thus, the number of accesses to the right-click data is counted. The right-click is an example of a method of accessing a public file, and any other method may be used as long as it is a method of instructing a public file to be accessed by a user. For example, the right-click may be replaced with a single click or a double click.

Upon receiving the public file operation information, the user terminal 2 displays a public file operation menu (see 2002 in FIG. 20) based on the public file operation information.

(2) Access to Sample Data and Counting of Access Times

As shown in FIG. 20, in the data display menu 2008 of the public file operation menu 2002, there is a line drawn as “sample data display” indicating that sample data is displayed. When the user of the user terminal 2 selects this line by clicking or the like, the data management device 100 transmits sample data to the user terminal 2, and the user terminal 2 displays the sample data. The user terminal 2 may store the sample data instead of displaying the sample data. The number of times of access monitoring unit 114 of the data management device 100 executes the access count counting process to increase the value of the access count of the right-click data sample data in the right-click data record in the access counter table 124 by one. Thus, the access count of the right-click data sample data is counted. The number of times of access to the data 707 and the applied policies 705 in the access counter table 124 are the number of times of access of modify processing information for storing the number of times of access to the modified data (number of times of access to the data 707) and the modify processing name (applied policies 705) applied to generate the modified data in association with each other.

(3) Generation of Modified Data (Modified Data Disclosure Processing)

As shown in FIG. 20, applicable modify process names are arranged in the “recommended data modifying menu” 2007 of the public file operation menu 2002. When the user of the user terminal 2 selects the applicable modify process name of the “recommended data modifying menu” 2007 by clicking or the like, the data management device 100 modified data disclosure unit 113 generates modified data d3 by applying the modify processing of the selected modify processing name (applicable modify process name) selected by the user to the right-click data in the modified data disclosure processing as follows, and stores the modified data d3 in the public data store 125 to publish it.

The data management device 100 first acquires the program ID associated with the selected modify processing name (applicable modify process name) selected by the user from the information modify processing table.

Next, the data management device 100 executes the modify processing program associated with the acquired program ID to generate the modified data d3 and the sample data of the modified data d3 obtained by applying the applicable modify processing to the right-click data, and stores the modified data d3 and the sample data in the public data store 125 to publish the modified data d3. The generated modified data d3 icon is displayed on the data viewing screen 2000 of the user terminal 2.

Further, the data management device 100 registers the modified data information relating to the generated modified data d3 in the access counter table 124. The data management device 100 transmits the modified data information to the control plane 200. Upon receiving the modified data information, the control plane 200 stores the information relating to the generated modified data d3 in the data catalog table 225 and the data status table 226 based on the modified data information.

As described above, the user of the user terminal 2 right-clicks the modified data d3 to display the sample data of the modified data d3 or to generate the modified data d31 by applying the applicable modify processing to the modified data d3. As described above, the data management device 100 records the number of accesses to the modified data d3 and the sample data of the modified data d3 in the data status table.

(4) Calculation of Display Priority

The data management device 100 transmits the access counter table 124 to the control plane 200 every predetermined time interval (for example, one day). Upon receiving the access counter table 124 from the data management device 100, the control plane 200 stores the data included in the access counter table 124 in the data status table 226.

Then, the priority calculation unit 212 of the control plane 200 calculates the display priority for the modify processing name for each area as follows, and stores the information on the display priority for the modify processing name in the display priority table 227.

The control plane 200 first calculates the points of the modify processing for each record of the data status table 226 as follows.

Modify processing points=number of accesses to public data or modified data·weight w+number of accesses to sample data·weight ws

For example, assuming that the weight w=5 and the weight ws=1, in the data status table 226 of FIG. 12, for the record whose data-ID is 1, the modification processing applied to generate the file name “Member_ListA1.csv” in the data status table 226 of FIG. 12 is “date format conversion” in the column of modify processing name (Applied policy), and the points of the modify processing name “date format conversion” are calculated as follows.

“Date format conversion” points=200×5+100×1=1100

As described above, the control plane 200 calculates the points in association with the modify processing name for each area and each file using the data status table 226. The control plane 200 totals the points for each area and each modify processing name, and stores the modify processing name and the points in association with each area in the display priority table 227.

Next, the control plane 200 calculates the display priority so that the display priority becomes higher in descending order of points for each area (for example, the name of the modify processing having the largest points is set to display priority 1), and stores the calculated display priority in the display priority table 227. The control plane 200 calculates the display priority representing the order of the sum of the numbers of times of access to the modified data with respect to the modify processing name. The control plane 200 generates display priority information for storing the display priority 1303 and the modify processing name 1301 in association with each other, and stores the generated display priority information in the display priority table 227.

Furthermore, the control plane 200 transmits to the data management device 100 a display priority table 227 corresponding to the area in which the data management device 100 exists.

The data management device 100 receives the display priority table 227. The data management device 100 generates the public file operation information based on the display priority table 227. The public file operation information includes the applicable modify process name display priority information for storing the applicable modify process name in association with the display priority representing the order of magnitude of the sum of the numbers of times of access to the modified data with respect to the modify processing name calculated from the number of times of access of modify processing information. That is, as described above, when the user of the user terminal 2 right-clicks the icon of the public file (public data or modified data) in the user terminal 2, the user terminal 2 generates the public file operation information including the information in which the applicable modify process name in the recommended modifying menu 2007 is rearranged to the order of priority in the display priority table 227. Further, the recommended modifying menu 2007 in which the modify processing name (applicable modify process name) applicable to the right-click data is rearranged to the order of priority is displayed in the user terminal 2. Thus, the user can easily apply the applicable modify processing, which is considered to be highly convenient because it has been frequently used in the past, to the right-click data.

The following describes a method in which the administrator of the control plane 200 edits the data acquisition area policy table 221 and the data sharing area policy table 222 stored in the sub-memory device 233 of the control plane 200. The administrator of the control plane 200 operates an input device (for example, the user terminal 2a in FIG. 1) connected to the control plane 200 via a network such as the network NW1. The input device has the same configuration as the user terminal 2. The input device is connected to the control plane 200 via a network such as the network NW1.

When the administrator of the control plane 200 causes the input device to access the control plane 200 to activate the policy table edit program, the policy table edit screen is displayed on the input device. Instead of the administrator operating the input device, the administrator may operate the control plane 200. That is, the control plane 200 may further include an input output device such as a keyboard and a display, and the administrator may use the input output device to operate the control plane 200 to activate the policy table edit program to display the policy edit screen on the control plane 200.

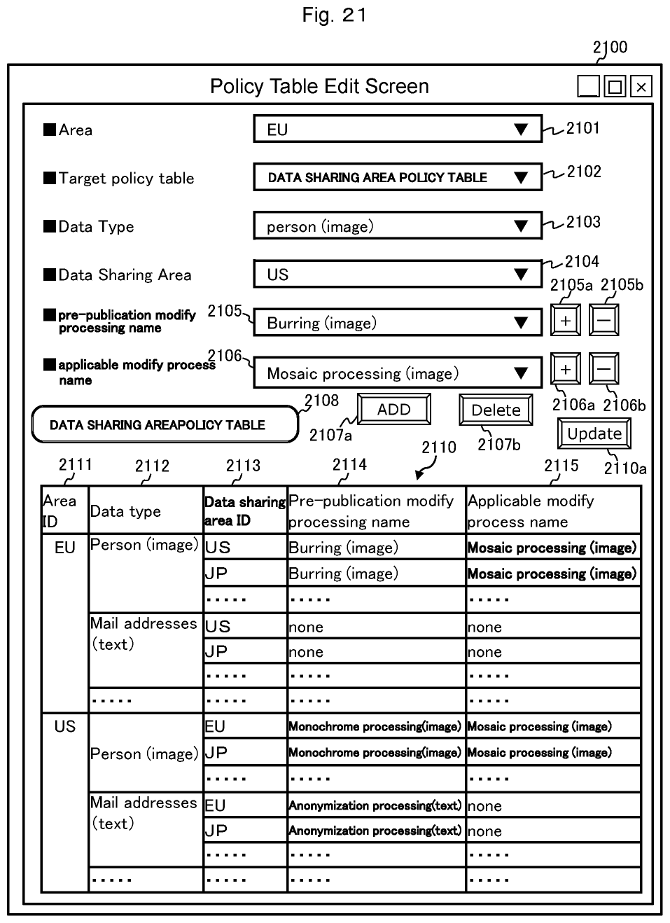

FIG. 21 is an explanatory diagram showing a policy table edit screen. An example of the policy table edit screen 2100 shown in FIG. 21 includes an area selection button 2101, an object policy table selection button 2102, a data type selection button 2103, a data sharing area selection button 2104, a pre-publication modify processing name selection button 2105, a process name add button 2105a, a process name delete button 2105b, an applicable modify process name selection button 2106, a process name add button 2106a, a process name delete button 2106b, an add record button 2107a, a delete record button 2107b, a control policy table name display field 2108, a policy table 2110, and an update button 2110a.

The area selection button 2101, the object policy table selection button 2102, the data type selection button 2103, the data sharing area selection button 2104, the pre-publication modify processing name selection button 2105, and the applicable modify process name selection button 2106 are associated with the fields of the records of the data sharing area policy table 222 (see FIG. 9).

The policy table 2110 is a table for editing the data sharing area policy table 222 shown in FIG. 9. The policy table 2110 has, as fields, the area ID 2111, the data type 2112, the data sharing area ID 2113, the pre-publication modify processing name 2114, and the applicable modify process name 2115. These are the same as the area ID 901, the species name 902, the data sharing area ID 903, the pre-publication modify processing name 904, and the applicable modify process name 905 in the fields of the data sharing area policy table 222 shown in FIG. 9.

An area selection button 2101 is a menu for selecting an area for acquiring the original data (area to be the data acquisition area). When the administrator clicks the area selection button 2101, a menu of a list of areas is displayed, and the administrator can select an area for acquiring the original data from the menu of the area list.

When the administrator clicks the object policy table selection button 2102, a policy table selection menu in which “data acquisition area policy table” and “data sharing area policy table” are drawn is displayed, and the administrator can select either “data acquisition area policy table” or “data sharing area policy table” as the table to be edited from the policy table selection menu.

When the administrator clicks the data type selection button 2103, a menu of a list of data types is displayed, and the administrator can select a data type from the menu of the list of data types.

When the administrator clicks the data sharing area selection button 2104, a menu of a list of sharing areas in which the data management device 100 is installed is displayed, and the administrator can select one of the sharing areas from the menu of the list of sharing areas. When the administrator selects “data acquisition area policy table” with the object policy table selection button 2102, the menu of the list of sharing areas is not displayed even if the administrator clicks the data sharing area selection button 2104.

When the administrator clicks the pre-publication modify processing name selection button 2105, a menu of a list of pre-publication modify processing names is displayed, and the administrator can select one of the pre-publication modify processing names from the menu of the list of pre-publication modify processing names. Here, a plurality of pre-publication modify processing names can be set. When the administrator clicks the process name add button 2105a, the administrator can click the pre-publication modify processing name selection button 2105 to add another pre-publication modify processing name. When the administrator clicks the process name delete button 2105b, the administrator can delete the most recently added pre-publication modify processing name.

When the administrator clicks the applicable modify process name selection button 2106, a menu of a list of applicable modify process names is displayed, and the administrator can select one of the applicable modify process names from the menu of the list of applicable modify process names. A plurality of applicable modify process names can be set. When the administrator clicks the process name add button 2105a, the administrator can click the applicable modify process name selection button 2106 to add another applicable modify process name. When the administrator clicks the process name delete button 2105b, the administrator can delete the most recently added applicable modify process name.

When the administrator clicks the add record button 2107a, the information (record) selected by the administrator using the area selection button 2101 to the applicable modify process name selection button 2106 is added to and stored in the data acquisition area policy table 221 or the data sharing area policy table 222 selected by the administrator using the area selection button 2101 and the object policy table selection button 2102.

On the other hand, when the administrator clicks the delete record button 2107b, a portion (record) of the data acquisition area policy table 221 or the data sharing area policy table 222 corresponding to the area selection button 2101, the object policy table selection button 2102, and the data type selection button 2103 selected by the administrator is deleted.

The control policy table name display field 2108 is a field in which an image of “data acquisition area policy table” or “data sharing area policy table” is displayed according to the selection of the object policy table selection button 2102 by the administrator.

In the policy table 2110 portion, when the administrator selects the area selection button 2101 and the object policy table selection button 2102, the data acquisition area policy table 221 or the data sharing area policy table 222 of the selected area from which the original data is to be acquired is read and displayed. The administrator can edit the data of the policy table 2110.

When the administrator clicks the update button 2100a, the value of the cell that the administrator edited and changed the value in the policy table 2110 is stored in the data acquisition area policy table 221 or the data sharing area policy table 222 corresponding to the policy table 2110.

Thus, in the embodiment, the data sharing system 1 publishes and shares the public data d2 and d2i generated by processing the data of the type (pre-publication modify type, see data type 501 in FIG. 5 and data type 601 in FIG. 6) of the data included in the original data d1, which needs to be processed before publication, based on the profile p (see FIG. 16) including the list of the type of the data included in the original data d1. Therefore, the data sharing system 1 facilitates the generation, publication, and sharing of the public data d2 and d2i obtained by processing the original data d1 including the data to be processed in the pre-publication before publication.

As described above, the data sharing system 1 can quickly share data around the world while complying with the data handling laws and regulations of countries around the world, such as the protection of privacy, and can quickly process the shared data appropriately. The data sharing system 1 can also reduce the amount of energy required to share data and the amount of carbon dioxide emissions generated, thereby suppressing global warming.

The data sharing system 1 stores area policy tables (the data acquisition area policy table 221 and the data sharing area policy table 222), and generates pre-publication modify processing information for each of the plurality of areas based on the area policy table and the profile, whereby pre-publication processing information can be easily generated. Consequently, the data sharing system 1 makes it easier to publish and share data.

In the data sharing system 1, the control plane 200 stores the area policy table. This facilitates management of the area policy table.

The data sharing system 1 generates and publishes sample data, so that users who refer to the public data can easily understand the outline of the public data.

Of the data management devices 100, the user terminal 2 can access the data management device 100 in the area where the user terminal 2 is located, and can refer to the public data (and its modified data) generated so as to be shared in the area where the user terminal 2 is located. In addition, the access of the user terminal 2 to the data management device 100 outside the area where the user terminal 2 is located is inhibited, and the user terminal 2 is inhibited from referring to the public data (and its modified data) stored in the data management device 100 outside the area where the user terminal 2 is located. Therefore, the public data that the user of the user terminal 2 can refer to is limited to the public data (and its modified data) generated for the area where the user terminal 2 is located. Thus, the data sharing system 1 can prevent the user of the user terminal 2 from referring to the inappropriate public data (and its modified data).

The acquired data management device 100a does not collectively generate the public data for data sharing area d2i. In the sharing area, the data management device 100 generates the public data for data sharing area d2i from the public data for data acquisition area d21. Thus, the public data for data sharing area d2i can be generated more quickly.

Based on the data reception information, the user terminal 2 can display that the public data for data acquisition area is disclosed before the public data for data acquisition area is disclosed. Then, the user using the public data for data acquisition area can know that the public data for data acquisition area is newly disclosed to the data management device 100 in the sharing area before the public data for data acquisition are is disclosed. Thus, the user using the public data for data acquisition area can utilize the public data more effectively.

The user terminal 2 can access public data and have the data management device 100 generate modified data by applying the modify processing of the selected modify processing name to the public data, which is selected from the applicable modify processing names displayed, so that the data sharing system 1 can easily generate and publish the modified data desired by the user.

The applicable modify process name display priority information that maps the name of modify processing to the display priority of the name of modify processing is sent to user terminal 2. User terminal 2 can retrieve the applicable modify process name display priority information that maps the name display priority to the applicable modify process name and display the applicable modify process name next to the applicable modify process name order of display priority based on the applicable modify process name display priority. This allows the user of user terminal 2 to more easily select the appropriate applicable modify process name and have the data management device 100 generate the appropriate modified data by applying the modify processing of the selected applicable modify process name to the public data. Therefore, the data sharing system 1 can more easily generate the appropriate modified data.

The display priority information is calculated for each area. Thus, the applicable modify process name can be arranged in the order of display priority according to the characteristics of the area and presented to the user of the user terminal 2. Thus, the user of the user terminal 2 can more easily select the appropriate applicable modify process name and cause the data management device 100 to generate the modified data by applying the modify processing of the selected applicable modify process name to the public data. Thus, the data sharing system 1 can more easily generate the appropriate modified data.

What is claimed is:

1. A data sharing system including data management devices in a plurality of areas, wherein the data management devices in the plurality of areas are connected to each other via a network and share data, the data sharing system comprising:
a profile generation unit configured to generate, when original data is acquired, a profile including information of a data acquisition area from which the original data is acquired and a list of types of data included in the original data;
a modify process information unit configured to generate, for each of the plurality of areas based on the profile, pre-publication modify processing information storing, in association with each other, the name of a pre-publication modify type of data to be modified before publication among types of data included in the original data and the name of a modify processing for modifying the data of the pre-publication modify type; and
a public data disclosure unit configured to generate public data obtained by modifying the original data by the modify processing based on the pre-publication modify processing information, and to store the public data in the data management device.

2. The data sharing system according to claim 1,
further comprising a memory unit
wherein the memory unit configured to store an area policy table storing in association with each other, the information which identifies the plurality of areas in which the data management device is located, the name of the pre-publication modify type, and the name of the modify processing for modifying the data of the pre-publication modify type; and
the modify process information unit generates the pre-publication modify processing information for each of the plurality of areas based on the area policy table and the profile.

3. The data sharing system according to claim 2,
further comprising a control plane connected to the data management devices in the plurality of areas via a network and comprising the memory unit.

4. The data sharing system according to claim 1, wherein:
the public data disclosure unit further generates sample data including summary information of the public data, and stores the public data and the sample data in the data management devices in the plurality of areas.

5. The data sharing system according to claim 1, wherein:
the network is further connected to a user terminal capable of transmitting and receiving information via the network; and
the user terminal is allowed to access, among the data management devices, the data management devices within the area where the user terminal is located,
and is restricted to access to data management devices outside the area where the user terminal is located.

6. The data sharing system according to claim 1, wherein:
Each of the data management devices of the plurality of areas, includes the profile generation unit and the public data disclosure unit;
in the acquired data management device that has acquired the original data, among the data management devices,
the profile generation unit generates the profile from the acquired original data,
the public data disclosure unit generates and stores public data to be published in the data acquisition area where the acquired data management device is located, as public data for data acquisition are, and
transmit the profile and the public data for data acquisition are, to the data management device in a sharing area other than the data acquisition area among the plurality of areas;
in the data management device in the sharing area,
the public data disclosure unit generates and stores the public data of the sharing area, as a public data for data sharing are, from the public data for data acquisition are based on the pre-publication modify processing information, when the profile and the public data for data acquisition are received.

7. The data sharing system according to claim 6, wherein: The data management device in the sharing area is configured to:
generates and stores data reception information indicating that the public data for data acquisition area has been received, when the data management device receives the profile and the public data for data acquisition are.

8. The data sharing system according to claim 1, wherein:
the network is further connected to a user terminal capable of transmitting and receiving information via the network;
the modify process information unit further generates, based on the profile, the modify process information unit further generates, based on the profile, applicable modify process information storing, in association with each other, the name of the applicable modify type of applicable modify data included in the public data, and the name of the modify processing that can modify the data of applicable modify type;
the public data disclosure unit stores the applicable modify process information together with the public data in the data management device;
the data management device comprising a modified data disclosure unit
wherein the modified data disclosure unit configured
to transmits the name of the applicable modify processing stored in the applicable modify process information, together with information of the public data, when the public data is accessed from the user terminal, and
to generate and to publish the modified data by applying the modify processing associated with received the selected modify processing name to the public data, when the data management device receives a selected modify processing name selected from the names of the applicable modify processing transmitted from the user terminal.

9. The data sharing system according to claim 8, wherein:
the data management device comprising a number of times of access counting unit
wherein the number of times of access counting unit configured
to calculate the number of times of access to the modified data by the user terminal; and
to generate and store number of times of access of modify processing information storing, in association with each other, the calculated number of times of access to the modified data, and the name of the modify processing applied to generate the modified data;
the modified data disclosure unit transmits applicable modify process name display priority information storing, in association with each other, the display priority indicating a size rank of the total sum of the number of times of access to the modified data corresponding to the name of the modify processing calculated from the number of times of access of modify processing information, and the name of the applicable modify processing, together with information of the public data to the user terminal,
when the public data is accessed from the user terminal.

10. The data sharing system according to claim 1, wherein:
the data sharing system further comprises a priority calculation unit;
the priority calculation unit, based on the acquired number of times of access of modify processing information, for each of the plurality of areas,
calculates the sum of the number of times of access to the modified data corresponding to the name of the modified processing,
calculates the display priority indicating a size rank of the total sum of the number of times of access to the modified data corresponding to the name of the modify processing,
generates and stores display priority information storing, in association with each other, the display priority and the name of the modify processing, and
transmits the generated display priority information to the data management device,
when the data sharing system acquire the number of times of access of modify processing information from the data management device of each of the plurality of areas;
the data management device acquires the display priority information from the priority calculation unit; and
the modified data disclosure unit generates the applicable modify process name display priority information based on the display priority information, and transmits the generated applicable modify process name display priority information, together with information of the public data to the user terminal,
when the public data is accessed from the user terminal.

11. A data sharing method of a data sharing system including data management devices in a plurality of areas, wherein the data management devices in the plurality of areas are connected to each other via a network and share data, the method comprising:
generates, when original data is acquired, a profile including information of a data acquisition area from which the original data is acquired and a list of types of data included in the original data;
generate, for each of the plurality of areas based on the profile, pre-publication modify processing information storing, in association with each other, the name of a pre-publication modify type of data to be modified before publication among types of data included in the original data and the name of a modify processing for modifying the data of the pre-publication modify type; and
generate public data obtained by modifying the original data by the modify processing based on the pre-publication modify processing information, and to store the public data in the data management device.
